(19) United States
(12) Patent Application Publication
(10) Pub. No.: US 2005/0193788 A1
(43) Pub. Date: Sep. 8, 2005

(54) Method and apparatus locating a keyhole and orienting a key to the keyhole

(76) Inventor: Alan Weiner, Newark, CA (US)

Correspondence Address: EARLE JENNINGS, 8 KENYON AVE, KENSINGTON, CA, 94708, US

(21) Appl. No.: 11/071,085

(22) Filed: Mar. 2, 2005

Related U.S. Application Data
(60) Provisional application No. 60/550,031, filed on Mar. 3, 2004.

(51) Int. Cl. E05B 47/00; E05B 15/08

(52) U.S. Cl. 70/454

(57) ABSTRACT

The invention includes apparatus aiding in locating a lock cylinder and orienting a key to the keyhole, which may preferably include a label. It may guide a person by providing high contrast visual and/or tactile clues. Preferably, applying light to the apparatus for at most two seconds causes it to visually communicate for at least thirty seconds. The invention includes a method for manufacturing the apparatus, as well as the apparatus and the mountable apparatus as products of manufacturing. The invention includes installing the apparatus on a lock. The mounted apparatus and installed lock are products of installation. The invention includes using the apparatus. The inserted key in the keyhole is a product of the use of the apparatus. The inserted key in the keyhole may be used to engage the lock, or to disengage the lock.

### CROSS REFERENCES TO RELATED PATENT APPLICATIONS

This application claims priority to Provisional Patent Application 60/550,031 filed Mar. 3, 2004, and incorporated herein by reference.

### TECHNICAL FIELD

This invention relates to locating keyholes, and in particular orienting keys for insertion in the keyholes.

### BACKGROUND OF THE INVENTION

Many of us get frustrated, at least occasionally, trying to unlock a door. Many people encounter problems unlocking a door. One problem is actually locating the keyhole or keyway. This problem is common in a darkened situation, and also where the surroundings are very bright, but the lock is in a shadow or the users shadow falls across the lock face.

Once the lock is located, a second problem can arise, namely how to orient the key to correctly enter the lock. There is no standard for orienting the keyhole, no way for someone to be sure of the orientation in many situations. Although cylinder locks, at least in North America, have standardized on cylinder plug size, they have not standardized on key blade orientation, which may be keyed saw teeth or cuts up, down, right, or left.

For the visually impaired, these problems can be frequent irritants. In certain situations, these problems can make these people as well as anyone else vulnerable, by slowing down their entry into the protection of their private spaces, such as houses and apartments.

In hostile climates, problems unlocking a door may also extend the time people are exposed to extreme weather. For the young and the elderly, this can lead to increased chances of contracting colds, frostbite, and other illnesses.

Recently, small lights have been manufactured for use on key chains. The purpose of these lights is often to illuminate an area to find the keyhole. However, because these lights are on the key chain, they must be gotten out of the way so that the key can actually be inserted in the keyhole. When the light is most needed, it cannot be readily used. What is needed is a way to take advantage of the light when it is needed most, for inserting the key into the keyhole.

For clarity, common terms used by locksmiths and within this document are defined in the table below.

TABLE ONE
common terms used by locksmiths and as well
as some terms used within this application.

| Term | Meaning |
|---|---|
| blade | The part of the key that is inserted into the lock. |
| bow | The handle of the key. |
| cuts | A cut, or series of cuts, on the blade of a key. |
| cylinder key | A key for use with pin tumbler and wafer tumbler |
| | cylinder locks. |
| drivers | The pins in a lock that sit on top of the lower pins. |
| keyhole | Same as keyway. |
| keyway | The part of the plug where you insert the key. |
| lever lock | Lock with levers that are each lifted to the correct |
| | level by a bit key or flat metal key to enable the lock |
| | to operate. |
| lock cylinder | Refers herein to what is often known among locksmiths |
| | as “cylinder plug face”. |
| lower pins | The pins of a lock that contact the cuts on the key. |
| | Also called bottom pins. |
| plug | The part of the lock that you put the key into, and |
| | which turns to operate the lock. |
| saw teeth | Same as cuts. |
| shell | The outer part of the lock that surrounds the plug. |
| shoulder | The edge of the key that touches the face of the lock |
| | to define how far the key is inserted into the lock. |
| tip | The very end of part of the key that you stick into the |
| | lock first. |

### SUMMARY OF THE INVENTION

The invention includes apparatus aiding in locating a keyhole on a lock cylinder and orienting a key to the keyhole. The lock cylinder is also known as the cylinder lock plug. The apparatus was referred to in the provisional patent application as a keyhole locator. The keyhole is also known as a keyway. The means for finding the location of the lock cylinder will guide a person attempting to enter a key into the keyhole of the lock cylinder. The means for determining the orientation of the keyhole will guide the person attempting to enter the key into the keyhole as to the proper orientation of the key.

As used herein, a lock will include a lock cylinder containing the keyhole, the lock cylinder also includes the key interface, which when engaged by an inserted key, is used to lock and/or unlock the lock. The lock may be part of a automotive vehicle door, a door knob, or a dead bolt. The automotive vehicle door will refer to a door on an automotive vehicle. An automotive vehicle refers to a self-powered moving vehicle, which by way of example may include, but is not limited to, an automobile, a truck, a tractor, a fork lift, a combine, an airplane, and/or a crane. As used herein a door on an automotive vehicle may include, but is not limited to, a door to passenger section, a driver's section, a cargo compartment, an engine compartment, and a fuel supply point and/or compartment.

The apparatus may preferably include a means for mounting. The means for mounting may preferably include an adhesive and/or contact adhesive. The means for mounting may attach to the means for finding and/or the means for determining.

The apparatus may preferably include a label, which may preferably include the means for finding and the means for determining.

Certain embodiments of the apparatus may guide a person to the location of the lock cylinder, by preferably providing a high contrast visual clue. The apparatus may also guide as to the proper orientation of the key, by providing a high contrast visual clue. The apparatus may accomplish both these tasks in low light conditions, by storing and emitting any light shined on it.

The label may further, preferably, include means for receiving light energy, means for storing the light energy to create a stored energy, and means for broadcasting the stored energy to visually communicate the means for finding and the means for determining. Three materials may provide the means for receiving, the means for storing energy, and the means for broadcasting.

At least one of these three materials may use at least one of the following: at least one photo luminescent effect, at least one photovoltaic effect, at least one photoelectric effect, at least one piezo luminescent effect, and at least one piezo voltaic effect.

A luminescent material may preferably include these three materials, providing the means for receiving, storing and broadcasting. These three materials may preferably be the same luminescent material.

Preferably, applying the beam of a flashlight to the label for at most two seconds causes the means for broadcasting to visually communicate for at least thirty seconds. Further preferred, applying the beam of the flashlight for at most one second causes the means for broadcasting to visually communicate for at least forty five seconds. As used herein, a flashlight and a key light may be used in an equivalent manner.

Certain embodiments of the apparatus may include an embossed surface to provide similar keyhole location and key orientation clues by touch for the fully blind. As used herein the embossed surface may tactilely communicate the means for finding and the means for determining.

One preferred instance of the apparatus includes the label made with a luminescent material and configured to fit on the lock cylinder around the keyhole. The label is preferably thick enough to allow for tactile recognition, yet thin enough to allow key insertion to engage the lock pin tumblers or wafer tumblers of the lock.

The label may preferably be waterproof.

In certain preferred embodiments, the label may be Ultra-Violet (UV) protected.

The apparatus, in particular, the label may preferably have an outer shape of a semi-circle. It may further, preferably, have an inner shape around the keyhole when installed. The inner shape may be one of a semi-circle or a semi-rectangle. The inner shape may or may not be symmetrically arranged about the keyhole when installed.

The invention includes a method for manufacturing the apparatus, including the steps of making the means for finding and the means for determining to create a shaped apparatus, and removing shaped apparatus to create the apparatus.

The step of making may include cutting an outline of the means for finding and the means for determining on a sheet to create an apparatus outline on the sheet as the shaped apparatus and to create a waste zone on the sheet. The step of removing may also include removing the waste zone from the sheet to create the apparatus.

The sheet may further, preferably include an adhesive backing and/or a contact adhesive backing. The sheet may further, preferably include a non-stick backing layer to facilitate the step of removing the apparatus prior to application.

Alternatively, the step of making may include injecting an apparatus mold with a plastic to create the shaped apparatus. The step of removing may include removing the shaped apparatus from the apparatus mold to create the apparatus. The plastic may include at least one luminescent material. The method may further include applying a glue backing to the apparatus to create a mountable apparatus.

The invention includes the apparatus and the mountable end products of various embodiments of the manufacturing process.

The invention includes a method of installing the apparatus on a lock including the lock cylinder containing the keyhole. The method includes aligning the apparatus to the keyhole, and affixing the apparatus to the lock cylinder to create an installed lock. The installed lock is a product of the installation process.

In certain preferred embodiments, aligning to the keyhole may include aligning a primed stamp to the keyhole. Affixing the apparatus may further include pressing the primed stamp to the lock cylinder to provide the apparatus affixed to the lock cylinder and create the installed lock.

The method of installing may further include one of inking a stamp with an ink to create the primed stamp, priming the stamp with a paint to create the primed stamp, and applying a plastic to the stamp to create the primed stamp.

In certain embodiments, the apparatus may include at least one, and preferably two, alignment sites for positioning the apparatus on a lock around the keyhole.

The installation of a molded embodiment of the apparatus with positioning holes may be aided by the use of a positioning tool to engage the apparatus and press it against the cylinder plug face.

The invention includes a method of using the apparatus. The use includes positioning a key near the location of the lock cylinder, orienting the key using the orientation of the keyhole to create an aligned key, and inserting the aligned key into the keyhole to create an inserted key in the keyhole. When the lock is part of a door knob or dead bolt, the key may preferably include a keyed side of the key blade. The step of orienting may further preferably orient the keyed side to create an aligned key. The keyed side is sometimes referred to as the cut side. The inserted key in the keyhole is a product of the use of the apparatus. The inserted key in the keyhole may be used to engage the lock, or to disengage the lock.

### BRIEF DESCRIPTION OF THE DRAWINGS

FIGS. 1A to 1E show the use of the apparatus of the invention in locating a lock cylinder and orienting a key to the keyhole of the lock cylinder;

FIGS. 1F and 1G show additional orientation and lock cylinder details;

FIG. 2A, shows the use of the apparatus with a light source, for example, a flashlight or key light, to receive light energy and provide stored energy to visually communicate the location of the lock cylinder and the orientation of the keyhole;

FIGS. 2B to 2D, shows embodiments of the apparatus including an outer shape and an inner shape, both of which are semi-circles, an embossed surface, proper positioning of the apparatus on a lock face, and some of the possible packaging and user directions;

FIGS. 3A and 3B show the manufacture of the apparatus as a label from a sheet;

FIGS. 3C and 3D show one embodiment of the apparatus and the label of FIGS. 3A and 3B in terms of layers and means for receiving light energy, means for storing to create the stored energy, and means for broadcasting to visually communicate the means for finding the location of the lock cylinder and the means for determining the orientation of a keyhole;

FIGS. 4A to 4J provide some alternative apparatus in terms of outer shapes and inner shapes;

FIG. 4K shows specific sizing details of a preferred embodiment of a label included in the apparatus as shown in FIGS. 3A to 3D;

FIGS. 5A, 5B, and 5C show a stamp and its use to manufacture certain embodiments of the apparatus of the invention;

FIGS. 6A to 6D show some of the possible shapes for an injection molded version of the apparatus;

FIG. 7A shows a positioning tool that could be used with the injection molded versions of the apparatus of FIGS. 6A to 6D;

FIG. 7B shows the apparatus as a mountable apparatus including alignment sites; and

FIG. 7C shows the use of the positioning tool of FIG. 7A with the mountable apparatus of FIG. 7B to engage and disengage the apparatus for installation.

### DETAILED DESCRIPTION

The invention includes apparatus aiding in locating a keyhole on a lock cylinder and orienting a key to the keyhole. The lock cylinder is also known as cylinder lock plug. The apparatus was referred to in the provisional patent application as a keyhole locator. The keyhole is also known as a keyway. The means for finding the location of the lock cylinder will guide a person attempting to enter a key into the keyhole of the lock cylinder. The means for determining the orientation of the keyhole will guide the person attempting to enter the key into the keyhole as to the proper orientation of the key.

As used herein, a lock will include a lock cylinder containing the keyhole, the lock cylinder also includes the key interface, which when engaged by an inserted key, is used to lock and/or unlock the lock. The lock may be part of a automotive vehicle door, a door knob, or a dead bolt.

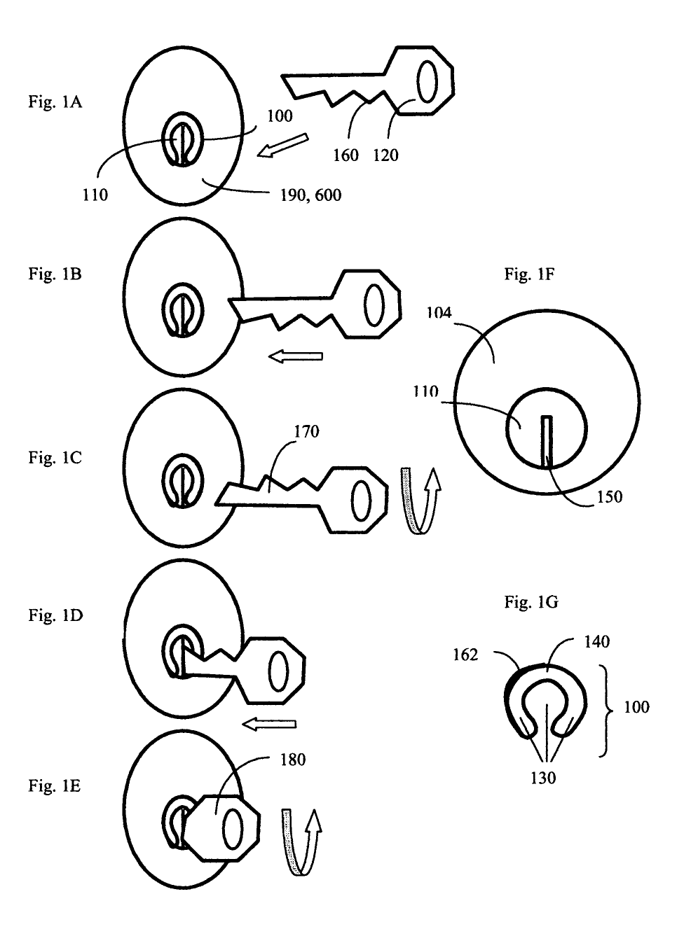

The invention includes apparatus 100 aiding in locating a keyhole 150 on a lock cylinder 110 and orienting a key 120 to the keyhole as shown in FIGS. 1A to 1C. The lock cylinder is also known as the cylinder lock plug. The apparatus was referred to in the provisional patent application as a keyhole locator 100. The keyhole is also known as a keyway. The means for finding 130 of FIG. 1G the location of the lock cylinder will guide a person attempting to enter a key into the keyhole of the lock cylinder. The means for determining 140 the orientation of the keyhole will guide the person attempting to enter the key into the keyhole as to the proper orientation of the key.

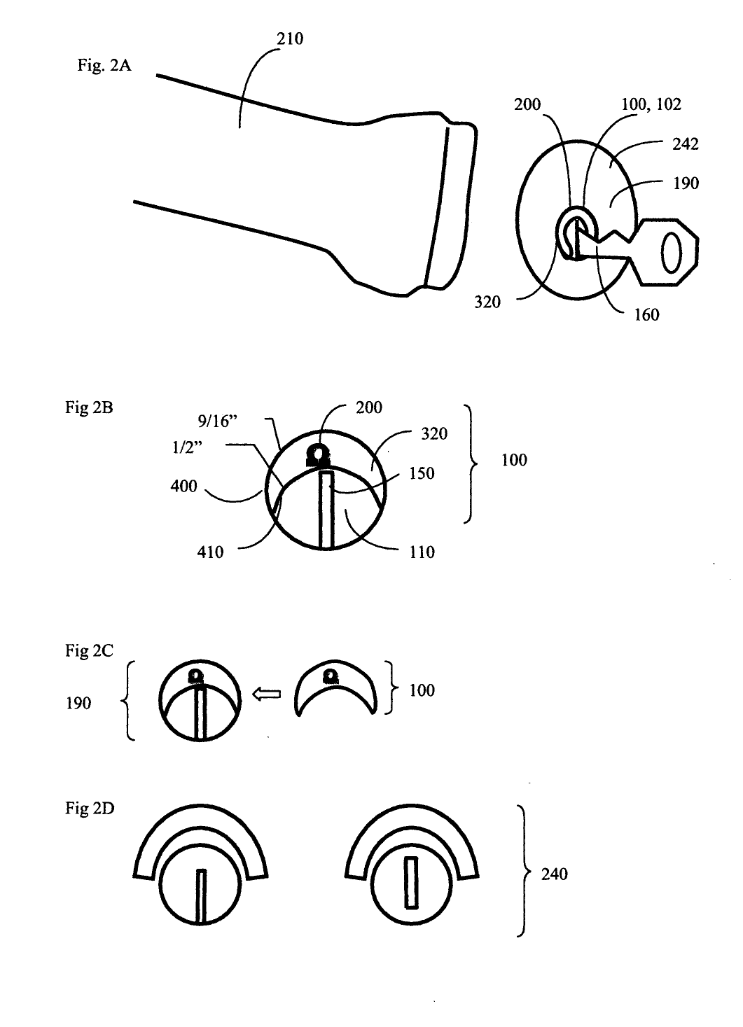

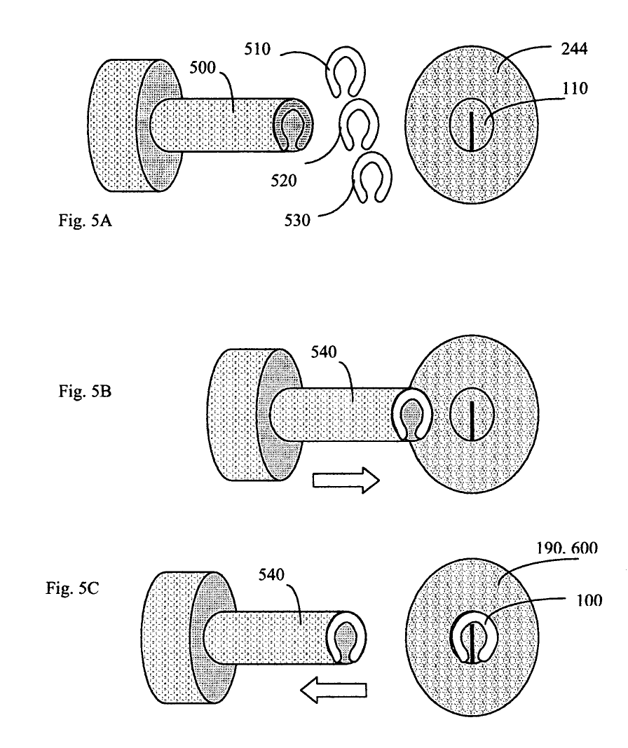

As used herein, a lock 104 as in FIG. 1F, will include a lock cylinder 110 containing the keyhole 150, the lock cylinder also includes the key interface, which when engaged by an inserted key 180, as in FIG. 1E, is used to lock and/or unlock the lock. The lock may be part of an automotive vehicle door 240 as in FIG. 2D, a door knob 244 as in FIG. 5A, or a dead bolt 242 as in FIG. 2A. The automotive vehicle door will refer to a door on an automotive vehicle. An automotive vehicle refers to a self-powered moving vehicle, which by way of example may include, but is not limited to, an automobile, a truck, a tractor, a fork lift, a combine, an airplane, and/or a crane. As used herein a door on an automotive vehicle may include, but is not limited to, a door to passenger section, a driver's section, a cargo compartment, an engine compartment, and a fuel supply point and/or compartment.

The apparatus may preferably include a means for mounting. The means for mounting may preferably include an adhesive and/or contact adhesive. The means for mounting may attach to the means for finding and/or the means for determining.

The apparatus 100 may preferably include a means for mounting 162. The means for mounting may preferably include an adhesive backing 340 and/or a contact adhesive backing 342. The means for mounting may attach to the means for finding 130 and/or the means for determining 140.

The invention includes a method of using the apparatus. The use includes positioning a key near the location of the lock cylinder, orienting the key using the orientation of the keyhole to create an aligned key, and inserting the aligned key into the keyhole to create an inserted key in the keyhole. When the lock is part of a door knob or dead bolt, the key may preferably include a keyed side of the key blade. The step of orienting may further preferably orient the keyed side to create an aligned key. The keyed side is sometimes referred to as the cut side. The inserted key in the keyhole is a product of the use of the apparatus. The inserted key in the keyhole may be used to engage the lock, or to disengage the lock.

The invention includes a method of using the apparatus 100. The use includes the following steps. Positioning a key 120 near the location of the lock cylinder 110 as in FIGS. 1A and 1B. Orienting the key using the orientation of the keyhole 150 to create an aligned key 170 as in FIG. 1C. And inserting the aligned key into the keyhole to create an inserted key 180 in the keyhole as in FIGS. 1D and 1E. When the lock 104 is part of a door knob 244 or dead bolt 242, the key may preferably include a keyed side 160 of the key blade. The step of orienting may further preferably orient the keyed side to create the aligned key. The keyed side is sometimes referred to as the cut side. The inserted key in the keyhole is a product of the use of the apparatus. The inserted key in the keyhole may be used to engage the lock, or to disengage the lock, by turning the inserted key in the keyhole, as in FIG. 1E.

The apparatus may include a label, which may preferably include the means for finding and the means for determining.

Certain embodiments of the apparatus may guide a person to the location of the lock cylinder, by preferably providing a high contrast visual clue. The apparatus may also guide as to the proper orientation of the key, by providing a high contrast visual clue. The apparatus may accomplish both these tasks in low light conditions, by storing and emitting any light shined on it.

The label may further include means for receiving light energy, means for storing the light energy to create a stored energy, and means for broadcasting the stored energy to visually communicate the means for finding and the means for determining. Three materials may provide the means for receiving, the means for storing energy, and the means for broadcasting.

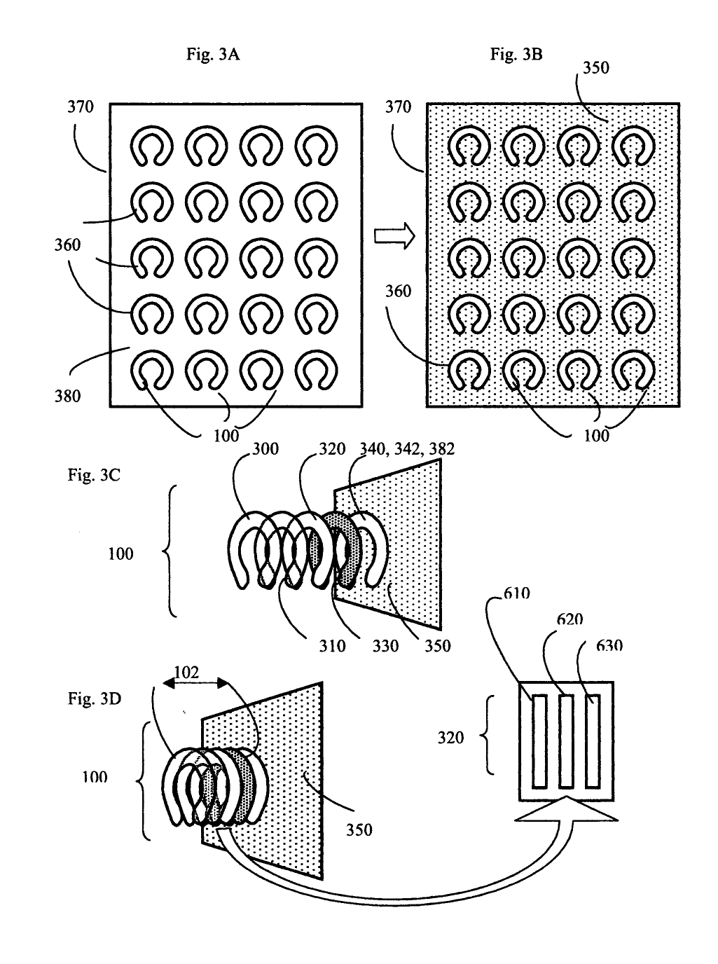

The apparatus 100 may include a label 102, which may preferably include the means for finding 130 and the means for determining 140 as in FIG. 3D.

Certain embodiments of the apparatus 100 may guide a person to the location of the lock cylinder 110, by preferably providing a high contrast visual clue. The apparatus may also guide as to the proper orientation of the key 120, by providing a high contrast visual clue. The apparatus may accomplish both these tasks in low light conditions, by storing and emitting any light shined on it.

The label 102 may further, as in FIG. 3D, preferably include a means for receiving 620 light energy, a means for storing 630 the light energy to create a stored energy, and a means for broadcasting 610 the stored energy to visually communicate the means for finding 130 and the means for determining 140. A first material may provide the means for receiving. A second material may provide the means for storing energy. A third material may provide the means for broadcasting.

At least one of these three materials may use at least one of the following: at least one photo luminescent effect, at least one photovoltaic effect, at least one photoelectric effect, at least one piezo luminescent effect, and at least one piezo voltaic effect.

A luminescent material 320 may preferably include these three materials, providing the means for receiving 620, the means for storing 630, and the means for broadcasting 610 as in FIG. 3D. These three materials may preferably be the same luminescent material.

Preferably, applying the beam of a flashlight 210 to the label 102 as in FIG. 2A, for at most two seconds causes the means for broadcasting 610 of FIG. 3D to visually communicate for at least thirty seconds. Further preferred, applying the beam of the flashlight for at most one second causes the means for broadcasting to visually communicate for at least forty five seconds. As used herein use of the flashlight 210 is equivalent to the use of a key light 210 with these embodiments of the invention.

Certain embodiments of the apparatus may include an embossed surface to provide similar keyhole location and key orientation clues by touch for the fully blind. As used herein the embossed surface may tactilely communicate the means for finding and the means for determining.

One preferred instance of the apparatus includes the label made with a luminescent material and configured to fit on the lock cylinder around the keyhole. The label is preferably thick enough to allow for tactile recognition, yet thin enough to allow key insertion to engage the lock pin tumblers or wafer tumblers of the lock.

Certain embodiments of the apparatus 100 may include an embossed surface 200 to provide similar keyhole 150 location and key orientation clues by touch for the fully blind. As used herein the embossed surface may tactilely communicate the means for finding 130 and the means for determining 140.

One preferred instance of the apparatus 100 includes the label 102 made with a luminescent material 320 as in FIG. 3D and configured to fit on the lock cylinder 110 around the keyhole 150 as in FIG. 1A to 1F. The label is preferably thick enough to allow for tactile recognition, yet thin enough to allow key 120 insertion to engage the lock pin tumblers or wafer tumblers of the lock 104.

FIG. 2A, brought forward from the provisional patent, shows the illuminated apparatus in use. The apparatus 100 is mounted on a lock 104 to create the mounted apparatus 190 and the installed lock 600 as in FIGS. 1A and 5C. A flashlight 210 or key light 210 can supply initial illumination. A luminescent material 320 picks up ambient light and glows in shadow or in dark. An embossed surface 200 helps to position the key 120, while the keyed side 160 face the bright center of the apparatus 100, providing the means for determining 140 the orientation of the keyhole 150.

The label 102 may preferably be waterproof. In certain preferred embodiments, the label may be Ultra-Violet (UV) protected. The label may preferably have a waterproof scratch-resistant surface. In certain preferred embodiments, the label 102 may be Ultra-Violet (UV) protected. In certain preferred embodiments, the luminescent material 320 may be UV protected. This may be accomplished additionally by inclusion of a UV screen as part of the luminescent material formulation.

FIG. 3C shows an example of layers that may be used to make a preferred embodiment of the label 102 included in the apparatus 100. On top of a non-stick backing layer 350 used to facilitate easy deployment of the apparatus, is an adhesive backing 340. On top of the adhesive backing 340 is an aluminized backing layer 330 to provide strength and some rigidly. On top of the aluminized backing layer 330 is a layer including a luminescent material 320 to provide high visibility in both lighted and unlighted situations. On top of the layer including the luminescent material is an optional UV protective layer 310 to provide long life in exposed situations that would otherwise prematurely degrade the luminescent layer. Finally, a mechanical protective layer 300 is supplied on top of the UV protective layer to protect the apparatus from exposure to the elements as well as provide additional rigidity. The mechanical protective layer is preferably transparent and scratch resistant.

FIGS. 3B and 3C show the apparatus 100 may preferably include both a label 102 and a non-stick backing layer 350.

The apparatus, in particular, the label may preferably have an outer shape of a semi-circle. It may further, preferably, have an inner shape around the keyhole when installed. The inner shape may be one of a semi-circle or a semi-rectangle. The inner shape may or may not be symmetrically arranged about the keyhole when installed.

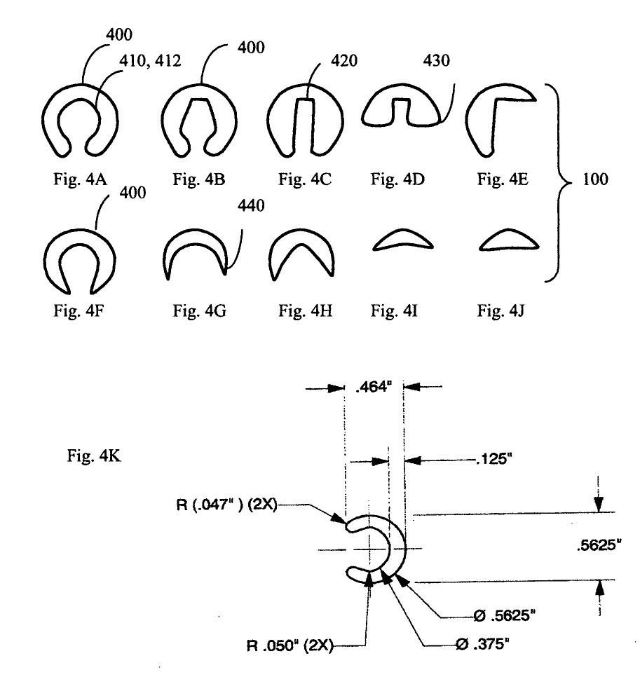

The apparatus 100, in particular, the label 102 may preferably have an outer shape 400 of a semi-circle. It may further, preferably, have an inner shape 410 around the keyhole 150 when installed. The inner shape may be a semi-circle as in FIGS. 2B, 4A, 4F, and 4G. The inner shape may also be a semi-rectangle as in FIGS. 4C, 4D, and 4E. Alternatively, the inner shape may have some other shape as in FIGS. 4B and 4H. The inner shape may be symmetrically arranged about the keyhole when installed as in FIGS. 1A to 1E. Alternatively, the inner shape may be asymmetrically arranged about the keyhole when installed, which would be the case for the embodiment of the apparatus as in FIG. 4E.

FIGS. 4A through 4J provide some alternative apparatus shapes. They should be considered examples of the apparatus 100 that suggest but do not exhaust the field of possible shapes. The embodiment of the apparatus should preferably have an outer shape 400 that does not go beyond the extent of the lock slug face, or lock cylinder 110. The apparatus may have an inner shape 410 that is a curved inner shape 412 or cornered inner shape 420. The inner shape preferably does not extend into the slug face area, or lock cylinder 110 needed by the keyway, or keyhole 150. The inner shape and outer shape may intersect as a rounded intersection 430 as in FIG. 4D or as a pointed intersection 440 as in FIG. 4G.

FIG. 4F shows the shape of 4A with pointed intersections 440. FIG. 4G shows the same shape as 4F with reduced material coverage; this shape is that suggested in the provisional patent and shown in FIGS. 2B and 2C. FIG. 4H shows the apparatus with still less material and a straighter inner shape. FIG. 4I extends the minimal material concept further. FIG. 4J extends the minimal material concept to the point where the apparatus is essentially a flat-bottom cap sitting on top of the keyway.

FIG. 4K shows the specific sizing details of a preferred embodiment of the label 102 included in the apparatus 100. The sizes shown in the Figure are preferred to accomplish a proper fit on the slug of a lock cylinder 110 for a North American style lock 104 are shown. The preferred inner shape 410, the outer shape 400 and the curved intersection of these shapes are shown.

The invention includes a method for manufacturing the apparatus, including the steps of making the means for finding and the means for determining to create a shaped apparatus, and removing shaped apparatus to create the apparatus.

The step of making may include cutting an outline of the means for finding and the means for determining on a sheet to create an apparatus outline on the sheet as the shaped apparatus and to create a waste zone on the sheet. The step of removing may also include removing the waste zone from the sheet to create the apparatus.

The sheet may further, preferably include an adhesive backing and/or a contact adhesive backing. The sheet may further, preferably include a non-stick backing layer to facilitate the step of removing the apparatus prior to application.

Alternatively, the step of making may include injecting an apparatus mold with a plastic to create the shaped apparatus. The step of removing may include removing the shaped apparatus from the apparatus mold to create the apparatus. The plastic may include at least one luminescent material. The method may further include applying a glue backing to the apparatus to create a mountable apparatus.

The invention includes the apparatus and the mountable end products of various embodiments of the manufacturing process.

The invention includes a method for manufacturing the apparatus 100, including the steps of making the means for finding and the means for determining to create a shaped apparatus, and removing shaped apparatus to create the apparatus.

FIGS. 3A and 3B show an example of a preferred embodiment of the method of manufacture using a sheet 370. FIG. 3C details an example of the layers of the apparatus 100 and label 102 which may be a preferred product of this embodiment of the manufacturing method.

The step of making may include cutting an outline of the means for finding and the means for determining on a sheet 370 to create an apparatus outline 360 on the sheet as the shaped apparatus 386 and a waste zone 380 on the sheet, as in FIG. 3A. The step of removing may also include removing the waste zone from the sheet to create the apparatus as in FIG. 3B.

The sheet 370 may further, preferably include an adhesive backing 340 and/or a contact adhesive backing 342 as in FIG. 3C. The sheet may further, preferably include a non-stick backing layer 350 to facilitate the step of removing the apparatus.

The sheet 370 is preferably a flexible laminated film coated with a permanent acrylic adhesive as the contact adhesive backing 342 and backed with a polycoated release liner non-stick backing layer 350. An exposure time of 5 minutes to sunlight tends to produce over an hour of glow on embodiments without UV blocking. An exposure 30 minutes to sunlight tends to product over tend hours of glow on embodiments with an UV protective layer 350.

The luminescent material 320 preferably contains at least one photo luminescent pigment. As used herein, photo luminescent pigments were first developed in 1976. These original pigments were fully annealed zinc sulfide crystals. More recently, pigments were introduced using strontium aluminate pigments. These pigments are much brighter than zinc and were the first UV resistant product on the market. They are the brightest and have the longest decline time on the market. The pigments store light energy (daylight or artificial light). They emit this energy as a bright, glowing, visible light in the darkness or through dense smoke and fog. They do not have any radioactive additives and are non-toxic.

Versions of the sheet 370 are currently manufactured by two companies. The first version is sold the brand name “Glo Bright™” and made by Jessup Manufacturing Company, Post Office Box 366, McHenry Ill. 60051 USA, which is preferred. The second version is the Permalite™ products, which are distributed in the United States by G. S. I. Inc., 3051 Pine Street, Clearwater, Fla., USA 33763-0914.

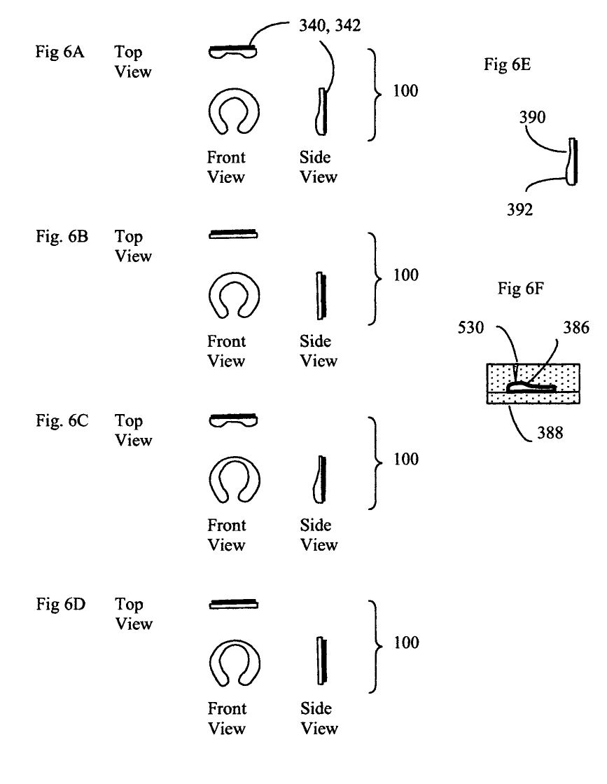

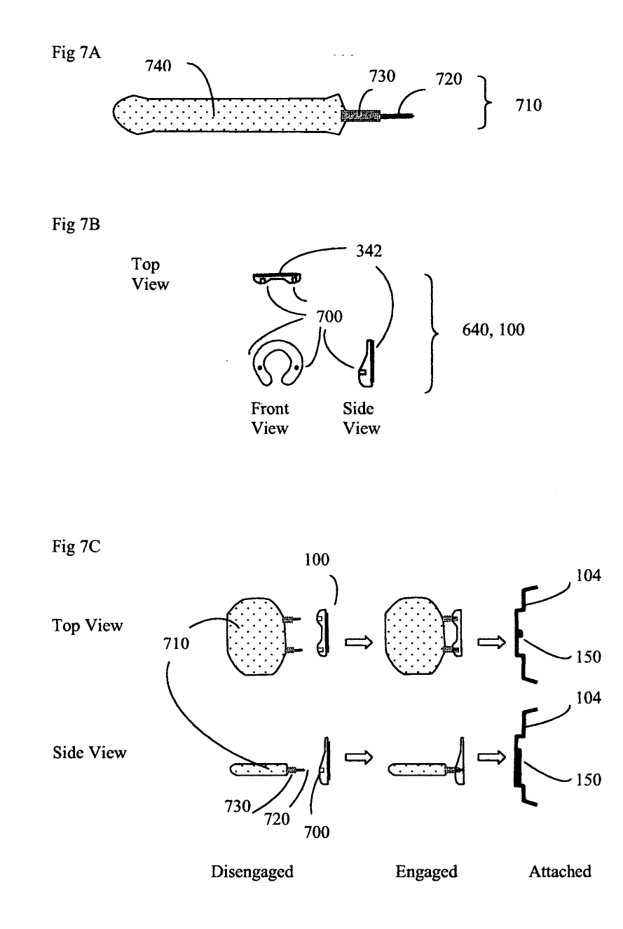

Alternatively, the step of making may include injecting an apparatus mold 388 with a plastic 530 to create the shaped apparatus 386, as in FIG. 6F. The step of removing may include removing the shaped apparatus from the apparatus mold to create the apparatus 100. The plastic may include at least one luminescent material 320 as in FIG. 3D. The method may further include applying a glue backing 382 to the apparatus to create a mountable apparatus 640 as in FIGS. 3C and 7B.

The invention includes the apparatus 100 and the mountable apparatus 640 of the various embodiments of the manufacturing process.

FIG. 2B also shows the dimensions of the outer shape 400 and the inner shape 410 for one preferred embodiment of the apparatus 100. The outer shape forms a semi-circle of about 9/16 of an inch. The inner shape forms a semi-circle of about half an inch.

FIG. 2C, which is brought forward from FIG. 2C of the provisional patent. The Figure in the provisional had installation instructions summarized in the text, “Keyhole locator. Peel crescent off of backing and position as shown in relation to keyhole. Carefully press into place.” It shows the apparatus 100 being affixed to a lock cylinder 110 to produce the mounted apparatus 190.

FIGS. 6A through 6D show some of the possible shapes for an injection molded (molded approach) version of the apparatus 100. These Figures show a front view, side view, and top view to make clear the three-dimensional aspects of the injection molds. The difference between the two-dimensional and three-dimensional implementations is that in the three-dimensional instances the raised portions of the apparatus enhance the tactile orientation feature of the apparatus 100. The edge on views of the apparatus 100 in FIG. 6A shows the adhesive backing 340 or the contact adhesive backing 342. FIG. 6A shows a thick-top three-dimensional embodiment of the apparatus. FIG. 6B shows a thick-top two-dimensional embodiment. FIG. 6C shows a thin-top three-dimensional embodiment. And FIG. 6D shows a thin-top two-dimensional embodiment.

The invention includes a method of installing the apparatus on a lock including the lock cylinder containing the keyhole. The method includes aligning the apparatus to the keyhole, and affixing the apparatus to the lock cylinder to create an installed lock. The installed lock is a product of the installation process.

In certain preferred embodiments, aligning to the keyhole may include aligning a primed stamp to the keyhole. Affixing the apparatus may further include pressing the primed stamp to the lock cylinder to provide the apparatus affixed to the lock cylinder and create the installed lock.

The method of installing may further include one of inking a stamp with an ink to create the primed stamp, priming the stamp with a paint to create the primed stamp, and applying a plastic to the stamp to create the primed stamp.

In certain embodiments, the apparatus may include at least one, and preferably two, alignment sites for positioning the apparatus on a lock around the keyhole.

The installation of a molded embodiment of the apparatus with alignment sites as positioning holes may be aided by the use of a positioning tool to engage the apparatus and press it against the cylinder plug face.

FIG. 1F shows a face-on view of the lock cylinder 110 in order to make clear the position and size of the keyhole 150.

The invention includes a method of installing the apparatus 100 on a lock 104 including the lock cylinder 110 containing the keyhole 150 as in FIG. 1F. The method includes aligning the apparatus to the keyhole, and affixing the apparatus to the lock cylinder to create an installed lock 600 and the mounted apparatus 190 as in FIG. 5C. The installed lock and mounted apparatus are products of the installation process.

FIG. 1G shows a face-on view of the apparatus 100 on an embodiment of the installed lock 600. The means for finding 130 shows the location of the lock cylinder between the horns and the means for determining 140 shows the orientation of the keyhole 150 as the keyed side 160 toward the bright area. Alternative installations may include the means for finding showing the location of the lock cylinder toward the bright area and the means for determining showing the orientation of the keyhole as between the horns. While these installations are possible and in certain cases preferred, the Figures of this document show the first installation to simplify the discussion and is not meant to limit the scope of the invention or its claims. FIG. 1G also shows the means for mounting 162 on the back of the apparatus 100.

In certain preferred embodiments, aligning to the keyhole 150 may include aligning a primed stamp 540 to the keyhole as in FIG. 5B. Affixing the apparatus 100 may further include pressing the primed stamp to the lock cylinder 110 to provide the apparatus affixed to the lock cylinder and create the installed lock 600.

The installation method may further include one of the following. Inking a stamp 500 with an ink 510 to create the primed stamp 540 as in FIGS. 5A and 5B. Priming the stamp with a paint 520 to create the primed stamp. And applying a plastic 530 to the stamp to create the primed stamp.

FIG. 5A also shows a preferred embodiment of the stamp 500 configured with an outline of the apparatus 100 on its stamp face. The stamp is preferably primed with an ink 510, or a paint 520, or a plastic 530 to create the primed stamp of FIG. 5B. The ink, the paint, and/or the plastic preferably include the luminescent material 320 as discussed elsewhere in this document. FIG. 5B shows pressing the primed stamp 540 to the lock plug face, or lock cylinder 110 to affix the apparatus to the lock cylinder in FIG. 5C. FIG. 5C shows the removal of the primed stamp, leaving the apparatus 100 mounted on the lock cylinder and creating the installed lock 600.

In certain embodiments, the apparatus 100 may include at least one alignment site 700, and preferably two, for positioning the apparatus on a lock 104 around the keyhole 150 as in FIG. 7C.

The installation of a molded embodiment of the apparatus 100 with at least one alignment site 700 formed as positioning holes may be aided by the use of a positioning tool 710 to engage the apparatus and press it against the lock cylinder 110, as in FIGS. 7A and 7C. The positioning tool may include at least one wire tip 720, and preferably two wire tips, coupled through a spacer 730 to a handle 740.

The preceding embodiments have been provided by way of example and are not meant to constrain the scope of the following claims.

1. An apparatus aiding the finding of a keyhole on a lock cylinder, comprising:
means for finding a location of said lock cylinder; and
means for determining an orientation of said keyhole.

2. The apparatus of claim 1, further comprising:
means for mounting at least one of said means for finding and said means for determining;
wherein said means for mounting, further including one of:
an adhesive backing of said means for finding and said means for determining; and
a contact adhesive backing of said means for finding and said means for determining.

3. The apparatus of claim 1, further comprising: a label including said means for finding and said means for determining.

4. The apparatus of claim 3, wherein said label, includes:
means for receiving a light energy;
means for storing said light energy to create a stored energy; and
means for broadcasting said stored energy to visually communicate said means for finding and said means for determining.

5. The apparatus of claim 4, wherein said label, further includes:
a first material providing said means for receiving;
a second material providing said means for storing; and
a third material providing said means for broadcasting;
wherein at least one of said first material, said second material, and said third material uses at least one of
at least one photo luminescent effect;
at least one photovoltaic effect;
at least one photoelectric effect;
at least one piezo luminescent effect; and
at least one piezo voltaic effect.

6. The apparatus of claim 5, wherein said label, further comprises:
a luminescent material including said first material, said second material, and said third material.

7. The apparatus of claim 4, wherein applying the beam of a flashlight to said label for at most two seconds causes said means for broadcasting to visually communicate for at least thirty seconds.

8. The apparatus of claim 4, wherein applying said beam of said flashlight to said label for at most one second causes said means for broadcasting to visually communicate for at least forty five seconds.

9. The apparatus of claim 3, wherein said label is waterproof.

10. The apparatus of claim 3, wherein said label is Ultra-Violet (UV) protected.

11. The apparatus of claim 3, wherein said label has an outer shape of a semi-circle.

12. A method of manufacturing said apparatus of claim 1, comprising the steps of:
making said means for finding and said means for determining to create a shaped apparatus; and
removing said shaped apparatus to create said apparatus.

13. The method of claim 12, wherein the step of making further comprises the step of:
cutting an outline of said means for finding and said means for determining on a sheet to create an apparatus outline on said sheet as said shaped apparatus and to create a waste zone on said sheet; and
wherein the step removing, further comprises the step of:
removing said waste zone from said sheet to create said apparatus.

14. The method of claim 12, wherein the step of making, further comprises the step of:
injecting an apparatus mold with a plastic to create said shaped apparatus; and
wherein the step of removing said shaped apparatus, further comprises the step of:
removing said shaped apparatus from said apparatus mold to create said apparatus.

15. The method of claim 14, further comprising the step of:
applying a glue backing to said apparatus to create a mountable apparatus.

16. The mountable apparatus as a product of the process of claim 15.

17. The method of claim 12, wherein said apparatus includes at least one luminescent material.

18. The apparatus as a product of the process of claim 12.

19. The method of installing said apparatus of claim 1 on a lock including said lock cylinder containing said keyhole, comprising the steps of:
aligning said apparatus to said keyhole; and
affixing said apparatus to said lock cylinder to create an installed lock.

20. The method of claim 19, wherein the step of aligning is further comprised of the step of:
aligning a primed stamp to said keyhole; and
wherein the step of affixing said apparatus is further comprised of the step of:
pressing said primed stamp to said lock cylinder to provide said apparatus affixed to said lock cylinder and create said installed lock.

21. The method of claim 20, further comprising one of the steps of:
inking a stamp with an ink to create said primed stamp;
priming said stamp with a paint to create said primed stamp; and
applying a plastic to said stamp to create said primed stamp.

22. The installed lock as a product of the process of claim 19.

23. The installed lock of claim 22 is part of at least one of a automotive vehicle door, a door knob and a dead bolt.

24. The method of using the apparatus of claim 1, further comprising the steps of:
positioning a key near said location of said lock cylinder;
orienting said key using said orientation of said keyhole to create an aligned key; and
inserting said aligned key into said keyhole to create an inserted key in said keyhole.

25. The inserted key in said keyhole as a product of the process of claim 24.
